(19) United States
(12) Patent Application Publication
(10) Pub. No.: US 2009/0119755 A1
(43) Pub. Date: May 7, 2009

(54) SYSTEM AND METHOD FOR ROLE BASED ACCESS CONTROL OF A DOCUMENT PROCESSING DEVICE

(76) Inventors: Marianne L. KODIMER, Huntington Beach, CA (US); Michael Yeung, Mission Viejo, CA (US); Amir Shahindoust, Laguna Niguel, CA (US); Girish R. Krishna, Torrance, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/352,000

(22) Filed: Jan. 12, 2009

Related U.S. Application Data
(63) Continuation-in-part of application No. 10/771,584, filed on Feb. 4, 2004, now Pat. No. 7,478,421.

(51) Int. Cl. G06F 21/00; G06F 17/00

(52) U.S. Cl. 726/4; 715/277

(57) ABSTRACT

The subject application is directed to a system and method for controlling access to a document processing device based on roles assigned to user groups. Each group of users has certain functions for which they are authorized to use a document processing device. The device determines the group to which the user belongs, and then determines those functions of the device for which the group is authorized. The device then compares the requested function with the authorized functions to determine if the group to which the user belongs is allowed to use the document processing device for the requested function. The document processing device then performs the authorized requested function or denies use of the device for an unauthorized function.

### CROSS-REFERENCE TO RELATED APPLICATIONS

This application is a continuation-in-part of U.S. patent application Ser. No. 10/771,584 entitled A System and Method for Role Based Access Control of a Document Processing Device filed Feb. 4, 2004.

### BACKGROUND OF THE INVENTION

This invention is directed to a system and method for role based access control of a document processing device, such as a multifunctional peripheral. More particularly, this invention is directed to system and method for role based access control of a document processing device which provides improved security to the users for managing document processing jobs.

Document processing devices, such as multifunctional peripherals, printing devices, copying devices, facsimiles, or scanning devices, typically provide minimal security to users of such devices for managing document processing jobs. For example, in currently available document processing devices, a user is able to walk up to the document processing device and delete other document processing jobs and place the user's job higher in the queue for processing. Another problem is that when a user selects a private document processing job, which are those jobs that have been created and left in the queue to be released once the user presents his password, the user selecting the private job is able to view the other private jobs in the queue, defeating the purpose of a private document processing job.

Several available document processing devices have attempted to overcome these problems in different ways. One device uses a feature to track and control the access of their peripherals. In this technique, there are 2000 to 2500 user accounts with unique PINS. The user must enter PINS in job control panel to obtain access to the copy function. The drawback of this approach is that only the copy function is protected in the device. This approach also does not support the matrix functionality of roles vs. the functions.

Another device uses a feature wherein the mailboxes are protected by a password. Upon the successful presentation of the password anyone can access the document. However, these devices have various drawbacks as described above. Thus there is a need for a system and method for role based access control of document processing devices which prevents users from performing functions which the users are not allowed to perform

### SUMMARY OF THE INVENTION

In accordance with one embodiment of the subject application, there is provided a system and method for controlling access to functionality of a document processing device based upon group membership. An electronic document is received by a document processing device which is capable of performing multiple functions. Document processing instruction data is then received corresponding to a user-selected operation corresponding to the received electronic document or an associated tangible document. A function of the document processing device is then determined in accordance with the selected operation. User data is then acquired of an identity of a user of the document processing device, which user data is associated with the received electronic document or associated tangible document. A group of users with whom the user is associated is then determined. Device access data of device access privileges associated with multiple groups is then received. A permission matrix template is then retrieved that specifies at least one allowable document processing function of the document processing device associated with each of a plurality of roles, with each role having at least a group or a user associated with usage of the document processing device. Permission matrix data is then generated based upon the role associated with the determined group and the permission matrix template, with the permission matrix data including data representing allowable document processing functions by a user associated with the at least one determined group. The permission matrix is then stored on a data storage associated with the controller of the document processing device. The controller then compares the determined function and determined role with the stored permission matrix data. Thereafter, operation of the document processing device is controlled to a subset of available document processing functions in accordance with the stored permission matrix such that use of the document processing function is prevented when not permitted by the stored permission matrix.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is diagram illustrating the system according to the present application;

FIG. 2 is a flow chart illustrating the method according to the present application;

FIG. 3 is a diagram illustrating a preferred role/resource correlation according to the present application;

FIG. 4a is a flowchart illustrating a method according to one embodiment of the subject application; and

FIG. 4b is a flowchart illustrating a method according to one embodiment of the subject application.

### DETAILED DESCRIPTION OF THE PREFERRED EMBODIMENT

Throughout this description, the preferred embodiment and examples shown should be considered as exemplars, rather than limitations, of the present invention. This invention is directed to a system and method for role based access control of a document processing device. More particularly, this invention is directed to a system and method of controlling who, among a wide variety of users, have access to the functions available on a typical document processing device. For example, an administrator may have authorization to use every function provided by the document processing device, whereas a secretarial user may have limited use of the functions provided by the document processing device.

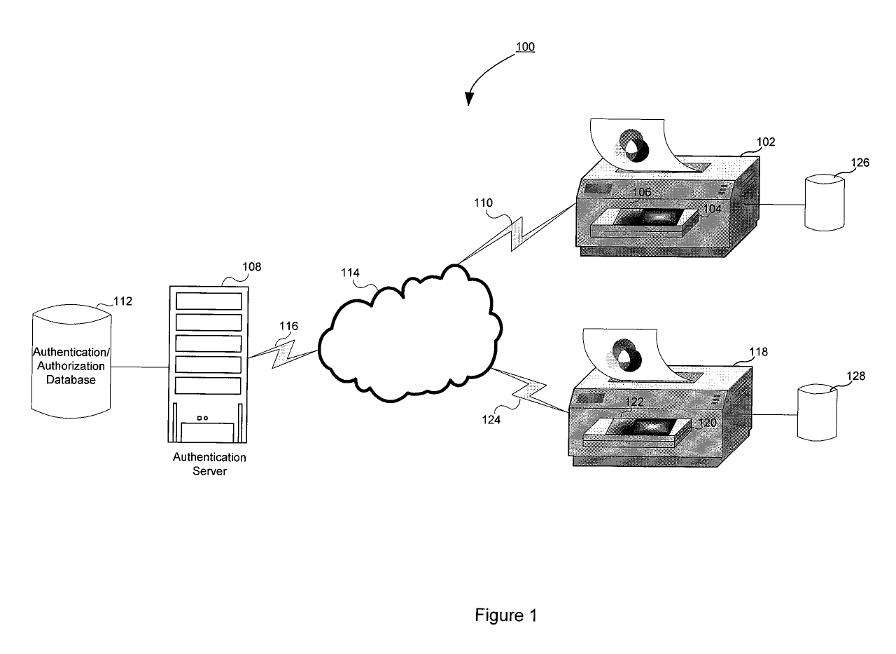

FIG. 1 is a diagram illustrating a preferred system 100 according to the present invention. The system includes a first document processing device 102 and a second document processing device 118. Such document processing devices 102 and 118 suitably include, for example and without limitation, multifunctional peripheral devices, copying machines, facsimiles, scanning devices, printing devices, storage devices, or workstations or terminals. The document processing devices 102 and 118 include controllers 104 and 120 for controlling the operations of the respective document processing device 102 or 118. The controllers 104 and 120 may be incorporated within the document processing devices 102 and 118, as shown, or may be an external component. The controllers 104 and 120 further include associated user interfaces 106 and 122 which allow users to select the function of the corresponding document processing device 102 or 118, as well as input the user's identification or username and password, as discussed below. The document processing devices 102 and 118 further include an associated data storage 126 and 128, on which is stored an internal database for roles, permissions, access rights, user data, groups, and the like. The skilled artisan will appreciate that such data storage 126 and 128 are capable of implementation as external or internal storage devices, e.g. an internal hard disk drive, or other suitable form of storage coupled to the document processing devices 102 and 118.

The document processing devices 102 and 118 are suitably connected to at least one server 108 via communications links 110, 116, and 124 over an associated computer network 114. The server 108 is preferably an authentication server. The server 108 includes a storage area or authentication database 112 for storing selected information, passwords and usernames or the like. In accordance with one embodiment of the subject application, the authentication database 112 includes an active directory, or lightweight directory access protocol (LDAP) based database storing user account information, user groups, roles, and the like. The skilled artisan will appreciate that such a database 112 is suitably accessible via the network 114. According to a further embodiment of the subject application, the database 112 is capable of supplying, via the server 108, rules, roles, groups, user data, permissions, and the like, to each of the databases 126 and 128 for implementation via the associated controllers 104 and 120 of the document processing devices 102 and 118.

The subject system is particularly advantageous in office document processing environments, and will be described in reference thereto. It is to be appreciated that the subject system is advantageously used in connection with any distributed, information processing environment in which enhanced throughput and efficiency is desired.

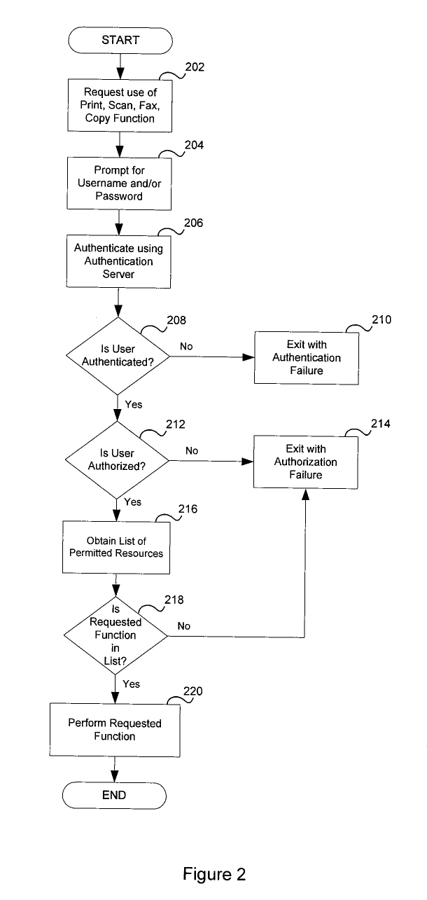

A flowchart illustrating the method according to the present invention is shown in FIG. 2. An associated user requests the use of the document processing device 102 to perform any of functions the document processing device 102 is capable of performing at step 202. The preferred embodiment utilizes the print, scan, facsimile, and copy functions of a multifunction peripheral device, however it will be appreciated by those skilled in the art that other functions may be attributed to the multifunction peripheral device. Further, the skilled artisan will understand that devices, other than the multifunction peripheral device, may equally provide a user with the ability to process documents. The user may request the performance of the function from a remote workstation, mobile device, wireless network client, or other electronic device capable of transmitting the document for processing. Alternatively, the user may physically approach the document processing device 102 and utilize the integral user interface 106, which may or may not be a graphical user interface.

In either situation, the user, after requesting the desired function at step 202, is prompted by the document processing device 102 at step 204 for the user's username and/or password. The inputted username and password are then compared with the corresponding pair of username and password stored on an authentication server 108 at 206. The authentication server 108 may be internal to the document processing device 102, or may be remotely accessible by the document processing device 102 over the communications link 110. The communications link 110 may be any form of wired or wireless communication methods known in the art. The authentication server 108 then informs the controller 104 that the user is authenticated. At 208, the controller 104 must determine that the user has been authenticated. In the event that the user improperly typed in the username or password, the controller 104 will interpret this to be an unauthenticated user and proceed to step 210, wherein the authentication fails and the user is exited from the system.

Returning to step 208, once the controller 104 has received the authentication information from the authentication server 108 and determined that the user is authenticated to use the document processing device 102, the authorization level of the authenticated user must be determined at step 212. The user, prior to using the functions of the document processing device 102, must first be authorized to use such functions as the user's role allows. For example, an authenticated user is determined by the system to be a senior administrator. Correspondingly, the senior administrator will be authorized to use a substantially larger number of functions than a summer intern. In the event that the user is determined at step 212 to lack authorization to use the document processing device 102 or the failure of the system to authorize the user, the controller 104 will exit the user from the system at 214.

When the user is authorized to use the document processing device 102 at 212, the level of such authorization must be determined. At step 216, a list of resources the user is authorized to utilize is transmitted to the controller 104 from the authentication server 108. The list of resources provides the controller 104 with a function-by-function authorization for the user or the group in which the user belongs. For example, the user may be authorized to scan, copy and print, but not be authorized to use the facsimile function. The list returned to the controller 104 contains the functions scan, copy and print, but does not contain the facsimile function, thus the user is not authorized to use that particular function of the document processing device 102. One skilled in the art will appreciate that the preceding example need not be limited to those functions stated, but rather may include numerous other functions.

The controller 104 on the document processing device 102 then compares the list of permitted functions retrieved at step 216 with the request input by the user at step 202 for compatibility. At step 218, the controller 104 then determines the requested function is not on the list of permitted functions for this particular user or the group to which the user belongs. The controller 104 then terminates the request at step 214 and the user is exited for authorization failure. When, at step 218, the controller 104 determines that the requested function from step 202 is contained within the list of authorized functions from step 216, the controller 104 directs the document processing device 102 to perform the function requested at step 220.

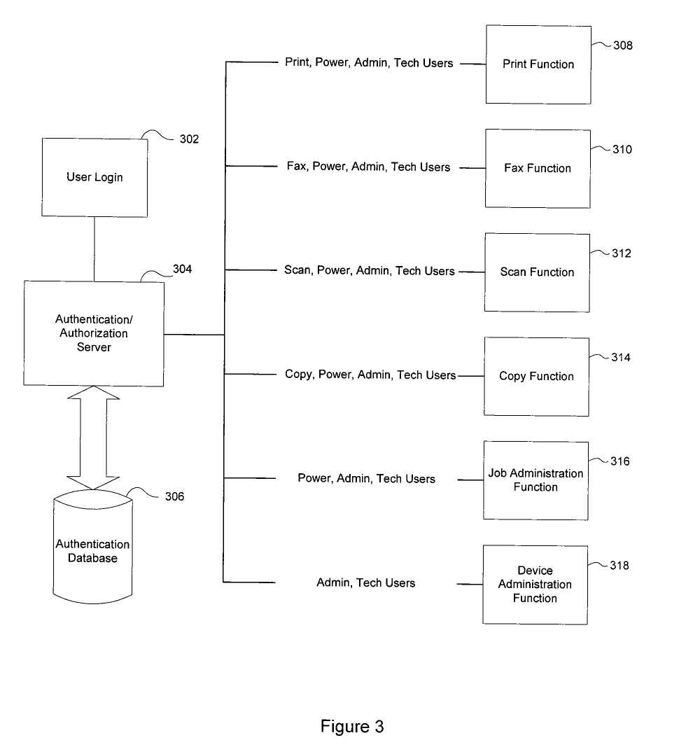

Referring now to FIG. 3, there is shown a diagram illustrating a preferred role/resource correlation according to the present invention. One skilled in the art will appreciate that the described allocation of resources is for exemplary purposes only, and should not be used to limit the method described above. A user logs into the controller 104 in order to authenticate and authorize as discussed in the method above, as shown at 302. The login 302 is transmitted to the authentication/authorization server 304 for verification. The server 304 retrieves from the authentication database, shown as 306, the list of authorized functions and authenticated user logins. The authentication/authorization server 304 then correlates the requested function with the functions shown as 308 through 318. It will be appreciated by those skilled in the art that the groups used in this example are created by a system administrator, enabling the administrator to control the level of access each user of the group has with respect to a document processing device 102.

The groups may be configured as determined by the administrator and individual users, depending upon their respective roles, may be members of more than one group. For example, the Print group of users is authorized only to use the print function 308 of the document processing device 102. The Fax group of users is authorized only to use the fax function 310 of the document processing device 102. The Scan group of users is authorized only to use the scan function 312 of the document processing device 102. The Copy group of users is authorized only to use the copy function 314 of the document processing device 102. The Power group of users is authorized to use the print function 308, the fax function 310, the scan function 312, the copy function 314 and the job administration function 316 of the document processing device 102. The Admin group of users is typically comprised of system administrators and is authorized to use all functions 308-318 of the document processing device 102. The Tech group of users typically comprises the technical support personnel charge with maintenance of the document processing device 102 and is authorized to use all of the functions 308-318 supported by the document processing device 102. The correlation described below should not be viewed to limit application of the foregoing method to only these groups.

The diagram of FIG. 3 denotes the six distinct functions capable of being performed by the document processing device 102. The first function is the print function 308. The print function 308 allows the document processing device 102 to act as a printer, printing documents transmitted to it over any communications channel or media known in the art. As shown in FIG. 3, the groups of users designated as Print, Power, Admin, and Tech all have equal rights to use the document processing device 102 as a printer. Each user of these respective groups is capable of sending a print job to the document processing device 102 for printing.

A second set of groups is authorized to use the facsimile function 310. These groups of users are the Fax, Power, Admin and Tech groups of users. Each member of these respective groups is authorized to use the facsimile function 310 of the document processing device 102. Thus, a user belonging to any of these groups may request a document be faxed by the document processing device 102. The third set of groups is authorized to use the scanning function 310 of the document processing device 102. These groups of users are the Scan, Power, Admin and Tech users, with each user authorized to scan a document using the document processing device 102. For example, using the method above, an authenticated user of the Power group may request a document be scanned by the document processing device 102. The controller 104 will then use the method above to determine the user belongs to the Power group and thus has rights to use the scan function 312 of the document processing device 102. The document processing device 102 will then scan the document accordingly.

The fourth set of groups is authorized to use the copy function 314 of the document processing device 102. These user groups are the Copy, Power, Admin and Tech users, with each user capable of requesting the document processing device 102 copy a document. The fifth group of users is authorized to change the administration of print, scanning, copying, or facsimile jobs of the document processing device 102 using the job administration function 316. Thus, users in the Power, Admin and Tech groups may adjust the properties of the job administration of the document processing device 102 by designating, for example, the order in which certain jobs are to be performed by the document processing device 102. The sixth set of user groups is authorized to change the device settings of the document processing device 102 using the device administration function 318. Thus, users belonging to the Admin and Tech groups are authorized to request changes made to the document processing device 102. The skilled artisan will appreciate that the designated groups of users have rights to configure the document processing device 102 settings, layout, hardware, software, and the like. It will be further appreciated that by enabling only certain groups of users to have rights to use certain correlating functions of a document processing device 102, office administration is made considerably easier.

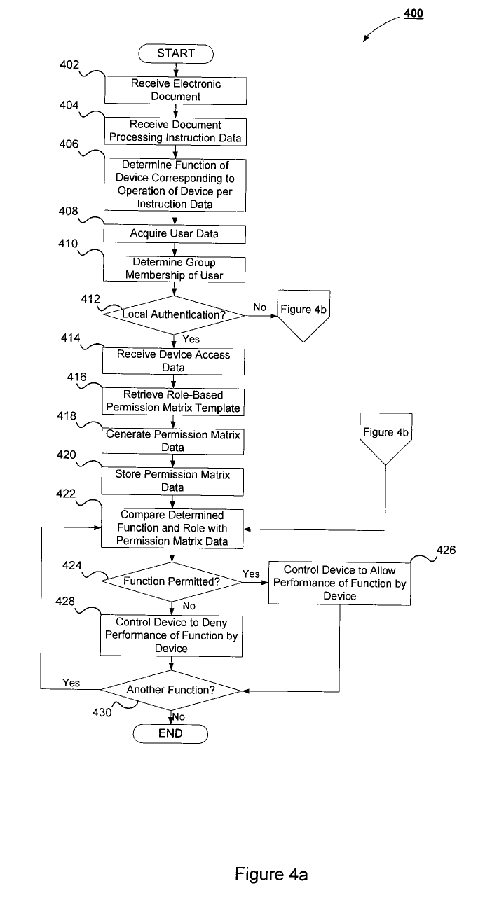

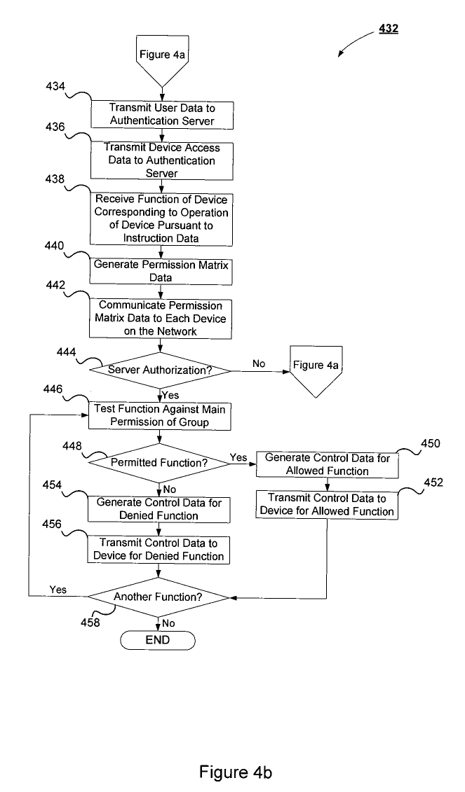

The skilled artisan will appreciate that the preceding embodiments reference the first document processing device 102 for example purposes only, and the subject application is capable of implementation on a network 114 to which are communicatively coupled a plurality of document processing devices 102, 118, and the like. Turning now to FIG. 4a, there is shown a flowchart 400 illustrating one example embodiment of the method for controlling access to functionality of a document processing device based upon group membership in accordance with the subject application. The methodology of FIG. 4a begins at step 402, whereupon an electronic document is received by the document processing device 102 or 118. As set forth in greater detail above, the document processing devices 102 and 118 are capable of performing a plurality of document processing operations, functions, or the like, as will be understood by those skilled in the art.

At step 404, the document processing device 102 or 118 receives document processing instruction data corresponding to at least one user-selected document processing operation corresponding to the received electronic document or a received tangible document. That is, the document processing device 102 or 118 receives a document processing request to be performed on the electronic document or on a tangible document provided by an associated user. From the instruction data, the controller 104 or 120, or other suitable component associated with the document processing device 102 or 118 determines at least one function of the device 102 or 118 that corresponds to the user-selected document processing operation at step 406. At step 408, user data is acquired representing the identity of a user of the document processing device 102 or 118. It will be appreciated by those skilled in the art that such user data is capable of being received via user interaction at the user interface 106 or 122, via electronic communication, or the like. In accordance with one embodiment of the subject application, the user data is associated with the received electronic document or the received tangible document, e.g. sent by the user with user data or provided via login at the device 102 or 118 upon provisioning of the tangible document.

At step 410, the controller 104 or 120 or other suitable component associated with the document processing devices 102 and 118 determines a group of users to which the user belongs based upon the received user data. Reference to such groups is made above with respect to FIG. 3 and corresponds to the group references made hereinafter to FIGS. 4a and 4b. Thus, suitable groups to which a user is capable of belonging include, for example and without limitation, administrators, power users, departmental based associations, and the like. The skilled artisan will appreciate that such groups are capable of having different privileges, or rights, with respect to using the various functions of the document processing devices 102 or 118. In accordance with one embodiment of the subject application, the controllers 104 and 120 access databases 126 and 128, respectively, to determine the appropriate group with which a user is associated. Preferably, each of the databases 126 and 128 include role, group, and user association data from the active directory database 112 communicated to the databases 126 and 128 via the network 114. According to another embodiment of the subject application, a master permission database associated with the groups, roles, users, associated rights, and the like, is cloned to each document processing device 102 or 118 for use in accordance with the methodology of FIG. 4.

A determination is then made at step 412 whether local authentication is to be performed. That is, whether the controller 104 or 120 associated with the document processing device 102 or 118 is to determine allowed function usage, or whether a remote server 108 is to be used. Upon a determination at step 412 that local authentication is not to be performed, flow process to step 434 of FIG. 4b, discussed in greater detail below. Upon a positive determination at step 412, operations proceed to step 414, whereupon receiving device access data is received representing device access privileges associated with each group, e.g. administrative users, power users, technical service users, and the like. The skilled artisan will appreciate that such groups are capable of being further limited to subgroups, or the like, such that within a group various classes of users are sub-grouped with further limitations on functions authorized for use on the document processing devices 102 and 118.

At step 416, a role-based permission matrix template is retrieved by the controller 104 or 120, or other suitable component associated with the document processing device 102 or 118. Preferably, the role-based permission matrix template specifies at least one allowable document processing function of the document processing device 102 or 118 associated respectively with multiple roles. In such an embodiment, each role includes at least one group or user associated with usage of the document processing device 102 or 118. Permission matrix data is then generated by the controller 104 or 120 at step 418 based upon the role associated with the group and the retrieved permission matrix template. According to one embodiment of the subject application, the permission matrix data includes data representing allowable document processing functions of the document processing device 102 or 118 by a user associated with the determined group. The permission matrix data is then stored on a data storage associated with the controller 104 or 120 of the document processing device 102 or 118 at step 420.

At step 422, the controller 104 or 120, or other suitable component associated with the document processing device 102 or 118 compares the determined function and determined role with the stored permission matrix data. In accordance with one embodiment of the subject application, the permission matrix data is communicated to the controller 104 or 120 from the authentication server 108, shown at step 422 from FIG. 4b, discussed more fully below. A determination is then made at step 424 whether the determined function is permitted based upon the comparison at step 422. Upon a determination that the function is permitted, flow proceeds to step 426. At step 426, the document processing device 102 or 118 is enabled to perform the allowed function. That is, operation of the document processing device 102 or 118 is controlled with respect to the permitted function in accordance with the determination made at step 424. Operations then proceed to step 430, whereupon a determination is made whether another function associated with the received instruction data remains for permission determination. Upon a positive determination, flow returns to step 422, whereupon the function and role are compared with the permission matrix data. A determination is then made at step 424 whether the function is permitted.

Upon a determination at step 424 that the function is not permitted, operations proceed to step 428. At step 428, the document processing device 102 or 118 is controlled by its respective controller 104 or 120 to deny performance of the function based upon the comparison of step 422. That is, the controller 104 or 120 denies the user the ability to use the requested function of the document processing device 102 or 118 as the role in which the user's group is associated does not permit such function of the device 102 or 118. According to one embodiment of the subject application, operations of the document processing device 102 or 118 are limited to a subset of available document processing functions based upon the stored permission matrix such that use of the document processing function is prevented when not permitted by the stored permission matrix. When no additional functions remain in the received instruction data, operations terminate after step 430.

Referring now to the flowchart 432 of FIG. 4b, from step 412 of FIG. 4a, the controller 104 or 120 transmits the received user data to the authentication server 108 via the associated network 114 at step 434. At step 436, the device access data is transmitted to the server 108 via the network 114 by the controller 104 or 120, or other suitable component associated with the document processing device 104 or 118. At step 438, the authentication server 108 receives each determined function associated with the document processing instruction data. That is, the server 108 receives data representing the desired function to be accessed by the user to perform the document processing operation indicated by the received instruction data.

At step 440, the server 108 generates permission matrix data via a comparison of the received user data and the received device access data. Once this matrix data has been generated, flow proceeds to step 442, whereupon the permission data matrix is communicated, via the network 114, to the controller 104 or 120 associated with each document processing device 102 or 118 associated with the network 114. A determination is made whether the server 108 is tasked to perform the authorization in accordance with the subject application at step 444. That is, a determination is made whether or not the server 108 is to determine the requested functions are allowable with respect to a given user. In the event that the server 108 is determined not to perform this action at step 444, operations then proceed to step 422 of FIG. 4a as set forth in greater detail above.

Returning to step 444, when it is determined that the server 108 is to authorize functions, flow proceeds to step 446. At step 446, the server 108 tests the determined function associated with the document processing instruction data against the permission matrix data associated with the determined group. A determination is then made at step 448 whether the determined function is permitted in accordance with the testing performed at step 446. When it is determined that the function is permitted with respect to the permission matrix data and the group to which the user belongs, flow proceeds to step 450, whereupon control data is generated by the server 108 allowing usage of the determined function by the user. At step 452, the control data is transmitted to the document processing device 102 or 118, whereupon the controller 104 or 120 operates the document processing device 102 or 118 in accordance with the permitted function. Operations then proceed to step 458 for a determination of whether any additional functions remain for processing in association with the received instruction data. When an additional function remains, flow returns to step 446 for testing as set forth above.

When it is determined at step 448 that the function is not permitted with respect to the permission matrix data and the group to which the user belongs, flow proceeds to step 454, whereupon control data is generated by the server 108 denying usage of the determined function of the document processing device 102 or 118 by the user. At step 456, the control data is transmitted to the document processing device 102 or 118, whereupon the controller 104 or 120 denies usage of the function of the document processing device 102 or 118 in accordance with the determination made by the server 108. Flow then proceed to step 458 for a determination of whether any additional functions remain for processing in association with the received instruction data. When an additional function remains, flow returns to step 446 for testing as set forth above. It will be appreciated by those skilled in the art that the server 108 is also capable of transmitting the generated control data denying or allowing a function to each of multiple document processing devices 102 and 118 coupled to the network 114 for use in determining whether to allow or deny a respective function to the user, regardless of the device 102 or 118 the user attempts use.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for controlling access to functionality of a document processing device based upon group membership, comprising:
means for receiving an electronic document into a document processing device, the document processing device including means for a plurality of document processing operations;
means for receiving document processing instruction data corresponding to at least one user-selected document processing operation corresponding to at least one of the received electronic document and an associated tangible document;
means for determining at least one function of the document processing device corresponding to the at least one user-selected document processing operation;
means for acquiring user data representative of an identity of a user of the document processing device, which user data is associated with at least one of the received electronic document and the associated tangible document;
means for determining at least one group of users associated with the user in accordance with the acquired user data;
means for receiving device access data representative of device access privileges associated with each of a plurality of groups, wherein each group includes at least one associated user;
means for retrieving a permission matrix template specifying at least one allowable document processing function of the document processing device associated with each of a plurality of roles, wherein each role includes at least one of a group and a user associated with usage of the document processing device;
means for generating permission matrix data in accordance with the role associated with the at least one determined group and retrieved permission matrix template, the permission matrix data including data representative of allowable document processing functions of the document processing device from a plurality thereof by a user associated with the at least one determined group;
means for storing the permission matrix on a data storage associated with the controller of the document processing device;
comparison means, associated with a controller of the document processing device, for comparing the determined function and determined role with the stored permission matrix data; and
means for controlling operation of the document processing device to a subset of available document processing functions in accordance with the stored permission matrix such that use of the document processing function is prevented when not permitted by the stored permission matrix.

2. The system of claim 1 further comprising:
means for transmitting, via an associated network, acquired user data to an authentication server;
means for transmitting, via the associated network, device access data to the authentication server;
wherein the authentication server compares the user data with the device access data to generate the permission matrix data.

3. The system of claim 2, further comprising:
means for receiving, at the authentication server, each determined function associated with the document processing instruction data; and
means for testing each determined function against the permission matrix data associated with the determined group.

4. The system of claim 3, wherein the server further comprises means for communicating the permission matrix data to each of a plurality of document processing devices via the associated network.

5. The system of claim 2, further comprising means for generating control data for control of the document processing device in accordance with an output of the testing means.

6. The system of claim 5, further comprising:
means for transmitting, to the document processing device, control data representative of an allowed function in accordance with an output of the testing means; and
means for transmitting, to the document processing device, control data representative of a denied function in accordance with an output of the testing means.

7. The system of claim 6, further comprising:
means for receiving control data from the authentication server; and
wherein the document processing device is controlled in accordance with the received control data such that use of the document processing function is prevented when not permitted by the control data and use of the document processing function is enabled when permitted by the control data.

8. The system of claim 7, wherein the control data is communicated to each of a plurality of document processing devices via the network.

9. A method for controlling access to functionality of a document processing device based upon group membership, comprising the steps of:
receiving an electronic document into a document processing device, the document processing device including a plurality of document processing functions;
receiving document processing instruction data corresponding to at least one user-selected document processing operation corresponding to at least one of the received electronic document and an associated tangible document;
determining at least one function of the document processing device corresponding to the at least one user-selected document processing operation;
acquiring user data representative of an identity of a user of the document processing device, which user data is associated with at least one of the received electronic document and the associated tangible document;
determining at least one group of users associated with the user in accordance with the acquired user data;
receiving device access data representative of device access privileges associated with each of a plurality of groups, wherein each group includes at least one associated user;
retrieving a permission matrix template specifying at least one allowable document processing function of the document processing device associated with each of a plurality of roles, wherein each role includes at least one of a group and a user associated with usage of the document processing device;
generating permission matrix data in accordance with the role associated with the at least one determined group and retrieved permission matrix template, the permission matrix data including data representative of allowable document processing functions of the document processing device from a plurality thereof by a user associated with the at least one determined group;
storing the permission matrix on a data storage associated with the controller of the document processing device;
comparing, at a controller associated with the document processing device, the determined function and determined role with the stored permission matrix data; and
controlling operation of the document processing device to a subset of available document processing functions in accordance with the stored permission matrix such that use of the document processing function is prevented when not permitted by the stored permission matrix.

10. The method of claim 9, further comprising the steps of:
transmitting, via an associated network, acquired user data to an authentication server;
transmitting, via the associated network, device access data to the authentication server;
wherein the authentication server compares the user data with the device access data to generate the permission matrix data.

11. The method of claim 10, further comprising the steps of:
receiving, at the authentication server, each determined function associated with the document processing instruction data; and
testing each determined function against the permission matrix data associated with the determined group.

12. The method of claim 11, further comprising the step of communicating the permission matrix data from the authentication server to each of a plurality of document processing devices via the associated network.

13. The method of claim 10, further comprising the step of generating control data for control of the document processing device in accordance with a result of the testing.

14. The method of claim 13, further comprising the steps of:
transmitting, to the document processing device, control data representative of an allowed function in accordance with a result of the testing; and
transmitting, to the document processing device, control data representative of a denied function in accordance with a result of the testing.

15. The method of claim 14, further comprising the steps of:
receiving control data from the authentication server; and
controlling the document processing device in accordance with the received control data such that use of the document processing function is prevented when not permitted by the control data and use of the document processing function is enabled when permitted by the control data.

16. The method of claim 15, further comprising the step of communicating the control data to each of a plurality of document processing devices via the network.
